(19) United States
(12) Patent Application Publication
(10) Pub. No.: US 2026/0290943 A1
(43) Pub. Date: Sep. 24, 2026

(54) BATTERY

(71) Applicants: Hyundai Motor Company, Seoul (KR); Kia Corporation, Seoul (KR); Valeo Kapec Co., Ltd., Dalseo-gu (KR)

(72) Inventors: Sang Wan KIM, Hwaseong-si (KR); Jun Young LIM, Hwaseong-si (KR); Se Hyeon PARK, Dalseo-gu (KR); Seung Min SHIN, Dalseo-gu (KR); Ki Hong LEE, Gangseo-gu (KR)

(21) Appl. No.: 19/323,507

(22) Filed: Sep. 9, 2025

(30) Foreign Application Priority Data
Mar. 24, 2025 (KR) 10-2025-0037309

(51) Int. Cl. H01M 10/6568; H01M 10/613; H01M 10/625; H01M 10/653; H01M 50/249

(52) U.S. Cl. CPC H01M 10/6568; H01M 10/613; H01M 10/625; H01M 10/653; H01M 50/249; H01M 2220/20

(57) ABSTRACT

A battery includes a lower panel having an open upper surface, the lower panel defining a cooling flow path configured to carry a cooling medium, an upper panel that covers the open upper surface of the lower panel and defines a cooling medium inlet and outlet holes at an end thereof, a cooling pipe that is connected to the cooling medium inlet or outlet hole and configured to circulate the cooling medium flow into or out of the lower panel, where the lower panel, the upper panel, and the cooling pipe part are integrated by brazing to define a battery cooling channel.

### CROSS REFERENCE TO RELATED APPLICATION

The present application claims priority to Korean Patent Application No. 10-2025-0037309, filed on March 24, 2025, the entire contents of which are incorporated herein for all purposes by this reference.

### TECHNICAL FIELD

The present disclosure relates to a battery.

### BACKGROUND

A battery is a device that stores electricity and is built into electronic devices, vehicles, etc. to power the electronic devices, vehicles, etc.

### SUMMARY

Hybrid vehicles can use both battery power and petroleum energy, where a battery may have a limited size. That is, when considering packaging of a vehicle in which numerous components are assembled, the size of the battery may not be increased without limitation. Accordingly, various techniques can be provided to increase battery energy density, for example, by increasing battery capacity while maintaining battery size or maintaining battery size while maintaining battery capacity.

The present disclosure describes a battery capable of cooling the battery built in a hybrid vehicle by using a water-cooling method.

According to one aspect of the subject matter described in this application a battery includes a lower panel having an open upper surface, the lower panel defining a cooling flow path configured to carry a cooling medium, an upper panel that covers the open upper surface of the lower panel and has a cooling medium inlet hole and a cooling medium outlet hole that are defined at an end portion of the upper panel, and a cooling pipe part connected to the cooling medium inlet hole and the cooling medium outlet hole, the cooling pipe part being configured to circulate the cooling medium into and out of the cooling flow path of the lower panel, where the lower panel, the upper panel, and the cooling pipe part are joined to one another to thereby define a battery cooling channel.

Implementations according to this aspect can include one or more of the following features. For example, the battery can further include a battery casing, where the lower panel defines a slot hole that couples the battery cooling channel to the battery casing, the slot hole being defined at a side surface of the lower panel. For example, the slot hole can have an oval shape having a major axis and a minor axis.

In some implementations, the battery can further include a battery pack disposed at an upper surface of the upper panel. In some implementations, the battery can further include a thermal interface material (TIM) layer disposed at the upper surface of the upper panel, where the battery pack is disposed at an upper surface of the TIM layer.

In some implementations, the battery can further include a buffer member that is disposed at an inner surface of the battery casing, where the battery cooling channel is disposed at an upper surface of the buffer member.

In some implementations, the cooling pipe part can include a cooling block having a first surface that is in contact with an inner surface of the battery casing and defines (i) a passage configured to provide the cooling medium toward the battery casing from an outside of the battery casing and (ii) a passage configured to provide the cooling medium outward from the battery casing to the outside. The cooling pipe part can include a cooling nipple having (i) a first end connected to one of the cooling medium inlet hole or the cooling medium outlet hole and (ii) a second end connected to a second surface of the cooling block.

In some examples, the first end of the cooling nipple can be connected to the upper panel by brazing with the cooling medium inlet hole or the cooling medium outlet hole, where the cooling block and the second end of the cooling nipple can be joined to each other by brazing.

In some examples, the battery casing defines a forming portion that is recessed from the inner surface of the battery casing and that has a shape corresponding to the cooling block, where the battery casing is configured to define a position of the battery cooling channel in longitudinal, width, and height directions based on the first surface of the cooling block being inserted into the forming portion.

In some examples, the cooling block can define a through-hole that extends through the cooling block and is connected to the second end of the cooling nipple. In some implementations, the battery can include a first seal, where the cooling block defines a first insertion groove at the first surface of the cooling block, the first insertion groove receiving the first seal. In some examples, the first insertion groove is defined along an edge of the cooling block or along a perimeter of the through-hole.

In some implementations, the battery can include a plurality of seals, where the cooling block defines a plurality of first insertion grooves at the first surface of the cooling block, each of the plurality of first insertion grooves receiving one of the plurality of seals. For example, the plurality of first insertion grooves can include (i) a first groove defined along an edge of the cooling block and (ii) a second groove defined along a perimeter of the through-hole.

In some implementations, the battery casing can define a middle hole at a position corresponding to the through-hole of the cooling block, the middle hole extending through the battery casing and being in fluid communication with the through-hole of the cooling block. In some examples, the battery can further include an external nipple inserted into the middle hole and the through-hole from an outer surface of the battery casing, where the external nipple and the cooling nipple are in fluid communication with each other.

In some implementations, the battery can further include a second seal, where the cooling block and the external nipple are fastened to each other by bolting, and the battery casing defines a second insertion groove along a perimeter of the middle hole, the insertion groove receiving the second seal.

In some implementations, the battery can include a first seal disposed between the battery casing and the cooling block, wherein the cooling block defines a first insertion groove at the first surface of the cooling block, the first insertion groove receiving the first seal, an external nipple inserted into the through-hole from an outer surface of the battery casing, and a second seal disposed between the external nipple and the battery casing, wherein the battery casing defines a second insertion groove receiving the second seal.

In some examples, the first seal can be one of a plurality of seals that are disposed between the battery casing and the cooling block, the plurality of seals being disposed along (i) an edge of the cooling block and (ii) a perimeter of the through-hole.

According to another aspect, a battery includes a lower panel having an open upper surface, the lower panel defining a cooling flow path configured to carry a cooling medium, an upper panel that covers the open upper surface of the lower panel and has a cooling medium inlet hole and a cooling medium outlet hole that are defined at an end portion of the upper panel, an inlet cooling pipe connected to the cooling medium inlet hole, and an outlet cooling pipe connected to the cooling medium outlet hole, where the inlet and outlet cooling pipes are joined to the upper panel by brazing.

In some implementations, watertightness can be secured through brazing, bolting, and gaskets.

In some implementations, by providing the forming portion in the battery casing, the battery cooling channel can be fixed to the battery casing after regulating the position of the cooling block, and by providing the slot hole in the lower panel to absorb assembly tolerances, assemblability can be secured between the battery cooling channel and the battery casing.

The effects of the present disclosure are not limited to those mentioned above, and other effects not mentioned will be clearly understood by those skilled in the art from the description provided hereinafter.

### BRIEF DESCRIPTION OF THE DRAWINGS

The above and other objects, features, and other advantages of the present disclosure will be more clearly understood from the following detailed description when taken in conjunction with the accompanying drawings.

FIG. 1 is an exploded view illustrating an example of a battery cooling channel included in a battery.

FIG. 2 is a view illustrating an example of an integrated battery cooling channel.

FIG. 3 is a view illustrating the integrated battery cooling channel, an example of a battery pack cooled by the battery cooling channel, and an example of a battery casing storing the battery cooling channel and the battery pack.

FIG. 4 is a top view illustrating the battery cooling channel coupled to the battery casing.

FIG. 5 is a top view illustrating an example of a forming portion and a cooling block of the battery casing.

FIG. 6 is a view illustrating the battery casing and an example of an external nipple coupled to an outer surface of the battery casing.

FIG. 7 is a sectional view taken along line A-A of FIG. 4.

### DETAILED DESCRIPTION

Hereinafter, various examples of the present disclosure will be described in detail with reference to the accompanying drawings, in which identical or similar elements are given the same reference numerals regardless of the reference numerals of the drawings, and repeated description thereof will be omitted.

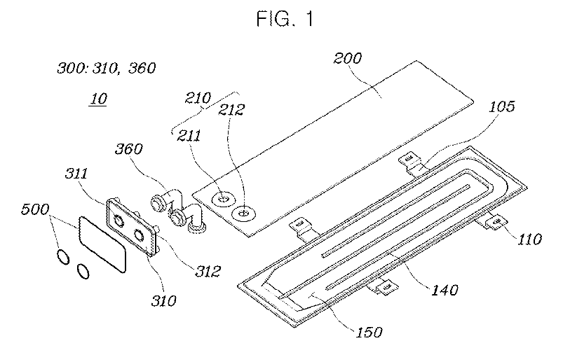

FIG. 1 is an exploded view illustrating an example of a battery cooling channel included in a battery. For example, the battery can be used in a hybrid vehicle. Batteries used in hybrid vehicles can be cooled by an air-cooling method or water-cooling method. The present disclosure discloses a battery cooled by a water-cooling method.

Referring to FIG. 1, in some implementations, a lower panel 100 and an upper panel 200 are coupled to each other to provide a space through which a cooling medium flows. The lower panel 100 has an open upper surface, and the open upper surface of the lower panel 100 is closed by coupling with the upper panel 200. In some implementations, the remaining three surfaces of the lower panel 100 other than the upper surface can be all closed, and the lower panel 100 is depressed so that a cooling flow path 150 through which the cooling medium flows is defined in a depressed portion. In some examples, a partition 140 defining the cooling flow path 150 can be formed on the depressed portion of the lower panel 100. The lower panel 100 and the upper panel 200 are made of a metal material, and specifically, can be manufactured from aluminum, which is lightweight and has excellent thermal conductivity.

The upper panel 200 covers the lower panel 100 to prevent the cooling medium flowing through the lower panel 100 from leaking out of the lower panel 100. In some implementations, a cooling medium inlet/outlet hole 210 for allowing the cooling medium to flow into and out of the lower panel 100 is formed at an end of the upper panel 200. The cooling medium inlet/outlet hole 210 includes a cooling medium inlet hole 211 that allows the cooling medium to flow into the lower panel 100 and a cooling medium outlet hole 212 that allows the cooling medium flowing through the cooling flow path 150 of the lower panel 100 to flow out of the lower panel 100. The cooling medium inlet hole 211 and the cooling medium outlet hole 212 can be formed singly or plurally.

In some examples, a cooling pipe part 300 can be connected again to the cooling medium inlet/outlet hole 210. The cooling pipe part 300 provides a passage for allowing the cooling medium to flow into the lower panel 100 or for allowing the cooling medium to flow out of the lower panel 100. For example, the cooling pipe part 300 can include a plate having one or more holes and one or more pipes connected to the plate.

In some implementations, in the battery, sealing performance can help prevent the cooling medium from leaking. This is because sealing is a factor to maintain the safety and performance of the battery. The battery generates internal heat while in operation. When this heat is not effectively controlled, it can lead to serious problems such as thermal runaway as well as performance degradation. To prevent this, the cooling medium is used to control the temperature of the battery. At this time, when sealing is not achieved properly, the cooling medium can leak and cause various problems.

In the present disclosure, in order to seal the cooling medium, the lower panel 100, the upper panel 200, and the cooling pipe part 300 are brazing welded to each other. Brazing is a method of joining different metal materials by heating them at a relatively low temperature (around 450°C) and melting a filler metal. Unlike general welding, brazing melts only a filler metal without meting base metals to fill a gap and then solidifies the filler metal to form a joint.

Brazing has an advantage of causing less heat distortion because is performed at a relatively low temperature, and can easily join different metal materials together. In some implementations, it has another advantage of ensuring excellent watertightness. In brazing, a low melting point metal filler such as solder can be used.

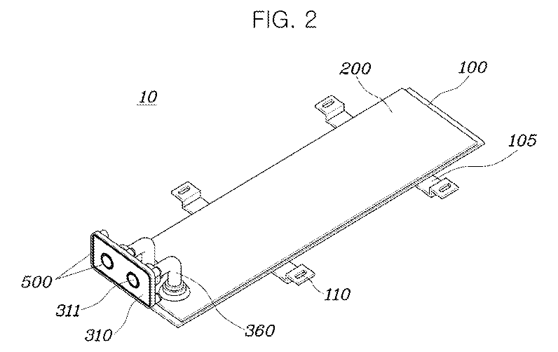

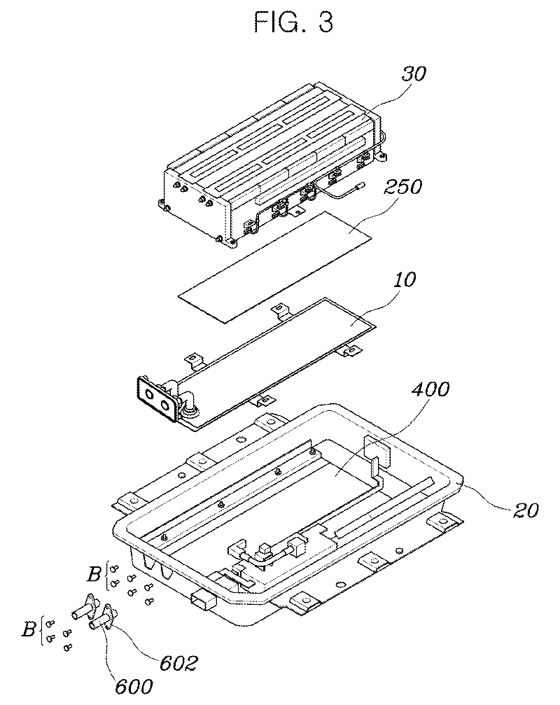

FIG. 2 is a view illustrating an integrated battery cooling channel 10 formed by the above-described process. FIG. 3 is a view illustrating the integrated battery cooling channel 10, a battery pack 30 cooled by the battery cooling channel 10, and a battery casing 20 storing the battery cooling channel 10 and the battery pack 30. Here, the battery casing 20 refers to a battery lower casing, and it can be understood that the above configurations are coupled to the battery lower casing, and then a battery upper casing is coupled to the battery lower casing to finally complete a battery.

In some implementations, a slot hole 110 for coupling the integrated battery cooling channel 10 to the battery casing 20 can be formed on a side surface of the lower panel 100. The slot hole 110 can be formed in a flange 105 extending laterally from a point on the side surface of the lower panel 100. The slot hole 110 of the lower panel 100 can be formed in a circular shape including a major axis and a minor axis shorter than the major axis. For example, the slot hole 110 is a hole processed in an elongated oval shape along the major axis. This structure serves to absorb assembly tolerances in an assembly process of coupling the battery cooling channel 10 to the battery casing 20, thereby improving assemblability and couplability between the battery cooling channel 10 and the battery casing 20.

More specifically, a bolt B or pin is adjusted within a specific range in the major axis direction of the slot hole 110, and even when a part does not fit in a correct position when assembled, the bolt B or pin is allowed to move within a specific range inside the slot hole 110, making position adjustment easy. This can help minimize alignment problems between parts caused by assembly tolerances or manufacturing errors. As illustrated in FIGS. 1 and 2, it is preferable that the slot hole 110 is formed on each of multiple flanges 105. For example, the slot hole 110 can be formed on each of four flanges 105 formed spaced a predetermined distance apart from each other on opposite sides of the lower panel 100, and the battery cooling channel 10 can be fixed at four points to the battery casing 20 and coupled to the battery casing 20.

In some implementations, the battery pack 30 can be disposed on an upper surface of the upper panel 200. The battery pack 30 is composed of a battery module including multiple battery cells. The battery module can also be composed of multiple battery modules. Since the upper panel 200 is made of aluminum and has excellent thermal conductivity, heat exchange can occur between the cooling medium flowing through the cooling flow path 150 of the lower panel 100, the upper panel 200, and the battery pack 30. The cooling medium that flows into the lower panel 100 through the cooling medium inlet hole 211 can cool the battery pack 30 and then flow out of the lower panel 100 through the cooling medium outlet hole 212.

In some implementations, a thermal interface material (TIM) layer 250 can be disposed on the upper surface of the upper panel 200, and the battery pack 30 can be disposed on an upper surface of the TIM layer 250. The TIM layer 250 can help improve thermal conductivity between the battery pack 30 and the upper panel 200. Even when the battery pack 30 comes into direct contact with the upper panel 200, thermal conductivity resistance can occur because of fine irregularities on a surface and an air gap. This air gap forms an air layer, and air becomes a factor that hinders effective heat transfer due to its low thermal conductivity. Therefore, applying the TIM layer 250 fills the air gap between the battery pack 30 and the upper panel 200, thereby reducing thermal conductivity resistance and enabling heat generated from the battery pack 30 to be released more efficiently.

The material constituting the TIM layer 250 can be selected in various ways depending on the purpose and performance specifications. For example, a thermal conductive paste can be provided in a viscous liquid form and can be easily applied to a contact surface of the battery pack 30 or the upper surface of the upper panel 200. This paste is based on silicon, and metal oxide such as alumina (AlO), silica (SiO), and boron nitride (BN) is added to increase thermal conductivity.

In some implementations, where the battery is generally located at the bottom of the vehicle, the vehicle can include a component that can provide protection of the battery from vibration and impact of the vehicle caused by driving on a road. For example, a buffer member 400 can be provided on an inner surface of the battery casing 20, the battery cooling channel 10 can be disposed on an upper surface of the buffer member 400, and then the battery cooling channel 10 can be coupled to the battery casing 20. The buffer member 400 serves to absorb impact and vibration between the battery pack 30 and the battery casing 20 and improves the structural safety of the battery. The buffer member 400 can generally be made of expanded polymer foam (EVA, PU, EPDM, EPP, etc.) with excellent impact absorption performance, rubber, or a composite material. These materials are lightweight yet effectively absorb impact, helping to improve battery protection while reducing an increase in vehicle weight.

In some implementations, the cooling pipe part 300 includes the following configurations. The cooling block 310 has a first surface coming into close contact with the inner surface of the battery casing 20 and defines a passage for the cooling medium flowing in from the outside of the battery casing 20 and a passage for the cooling medium flowing out from the battery casing 20 to the outside. For instance, the cooling block 310 can have a planar shape and include a plurality of passages that are defined therein and receive pipes. In some examples, a cooling nipple 360 has a first end connected to the cooling medium inlet/outlet hole 210 and a second end connected to a second surface of the cooling block 310 so that the cooling medium passing through the cooling block 310 flows into the lower panel 100, or the cooling medium passing through the lower panel 100 flows out to the outside through the cooling block 310. For example, as shown in FIG. 1, the cooling nipple 360 can include an inlet cooling pipe connected to the cooling medium inlet hole 211 and an outlet cooling pipe connected to the cooling medium outlet hole 212.

Furthermore, the first end of the cooling nipple 360 constituting the cooling pipe part 300 is brazing welded to the cooling medium inlet/outlet hole 210 so that the cooling nipple 360 is connected to the upper panel 200. As described above, by connecting the cooling nipple 360 and the cooling block 310 by brazing, the watertightness of the cooling pipe part 300 can be secured.

In some implementations, the second end of the cooling nipple 360 is also connected to the cooling block 310 by brazing, thereby securing watertightness. That is, as described above, the upper panel 200, the lower panel 100, and cooling pipe part 300 constituting the battery cooling channel 10 are all brazing welded to each other to secure watertightness.

In some implementations, an internal shape of the cooling pipe part 300 is designed to reduce the flow resistance of the cooling medium. An internal flow path is designed to optimize curvature to ensure even distribution of fluid flow and to prevent excessive turbulence. This can help increase cooling efficiency and reduce pressure loss within a system, ensuring smooth circulation of the cooling medium.

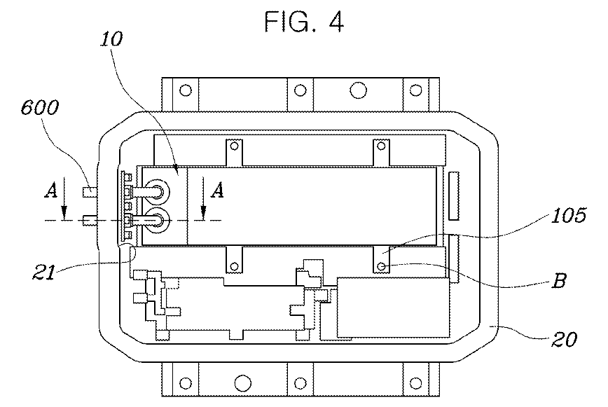

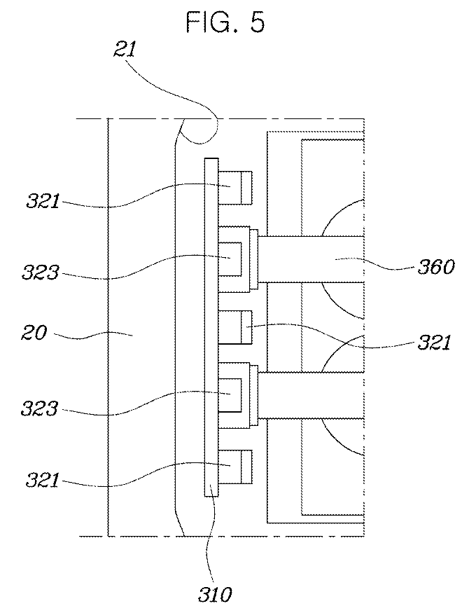

Furthermore, a forming portion 21 conforming to the shape of the cooling block 310 and recessed inwardly is formed on the inner surface of the battery casing 20. Referring to FIGS. 4 and 5, the forming portion 21 enables the cooling block 310 to come into close contact with the inner surface of the battery casing 20. When the cooling block 310 is brought into close contact with the forming portion 21, the positions of the integrated battery cooling channel 10 in the longitudinal, width, and height directions are regulated so that the battery cooling channel 10 is assembled to the battery casing 20 in that state.

More specifically, the forming portion 21 is formed on the inner surface of the battery casing 20 to ensure stable and close contact of the cooling block 310, where the forming portion 21 can help align and fix the position of the battery cooling channel 10. Since the cooling block 310 is disposed to correspond to the shape of the forming portion 21 rather than making contact with the inner surface of the battery casing 20, positional deviation can be minimized during an assembly process. That is, by enabling the cooling block 310 to come into close contact with the forming portion 21, the battery cooling channel 10 is aligned in the correct longitudinal, width, and height directions and is stably assembled to the battery casing 20. The forming portion 21 can be formed in a curved surface structure that matches the shape of the cooling block 310 and is designed to naturally engage with the cooling block 310 when the cooling block 310 is inserted.

In some implementations, the cooling block 310 can have a through-hole 311 penetrating the cooling block 310 and to which the second end of the cooling nipple 360 is connected. Referring to FIG. 5, the second end of the cooling nipple 360 can be inserted into and connected to the through-hole 311 of the cooling block 310. While the second end of the cooling nipple 360 is inserted into the through-hole 311 of the cooling block 310, the cooling block 310 and the cooling nipple 360 can be joined to each other by brazing.

In some implementations, a first insertion groove 312 recessed inwardly can be formed on the first surface of the cooling block 310, that is, on the first surface of the cooling block 310 that comes into contact with the inner surface of the battery casing 20, and a seal 500 (first seal) can be inserted into the first insertion groove 312. The seal 500 can be made of rubber or a composite material such as a gasket. In some implementations, the seal 500 seals a gap between the first surface of the cooling block 310 and the inner surface of the battery casing 20, thereby preventing foreign substances, external air, etc. from entering the gap between the cooling block 310 and the battery casing 20. A first fastening portion 321 and a third fastening portion 323 are formed in the cooling block 310. In the process of fastening the cooling block 310 to the inner surface of the battery casing 20 inside the battery casing 20 through the first fastening portion 321, the seal 500 is partially deformed and seals the gap between the first surface of the cooling block 310 and the inner surface of the battery casing 20. In some implementations, through an operation of bolting an external nipple 600, which will be described later, to the battery casing 20, the seal 500 inserted into the first insertion groove 312 is partially deformed and seals the gap between the first surface of the cooling block 310 and the inner surface of the battery casing 20.

In some implementations, it is preferable that the first insertion groove 312 is formed along the edge of the cooling block 310 and also along the perimeter of the through-hole 311 through which the cooling medium directly flows in and out so that the seal 500 is inserted into two positions to perform the sealing function.

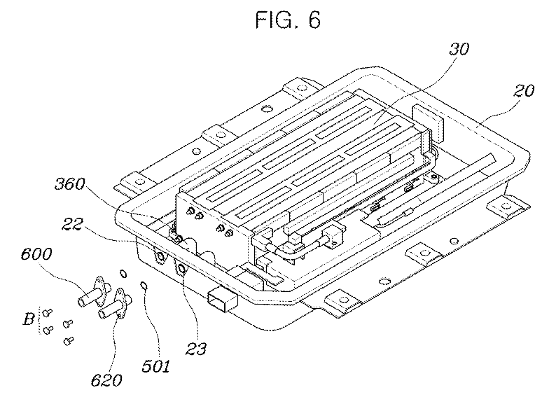

In some implementations, referring to FIG. 6, a middle hole 22 is formed in the battery casing 20 at a position corresponding to the through-hole 311 of the cooling block 310. The middle hole 22 is formed by penetrating the battery casing 20 and is in communication with the through-hole 311 of the cooling block 310. Therefore, the middle hole 22 is also in communication with the cooling nipple 360.

The external nipple 600 is coupled to the middle hole 22 from an outer surface of the battery casing 20, and an end of the external nipple 600 is inserted into the middle hole 22 and the through-hole 311. Accordingly, the external nipple 600 and the cooling nipple 360 are in communication with each other. The external nipple 600 allows the cooled cooling medium from the outside of the battery casing 20 to flow back into the lower panel 100 inside the battery casing 20 or allows the heated cooling medium to flow to a chiller, radiator, etc. after cooling the battery pack 30.

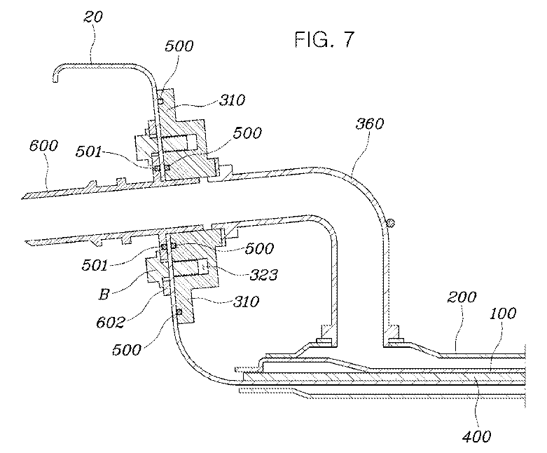

Referring to FIG. 7, the cooling block 310 and the external nipple 600 are fastened to each other by a bolt B. A second fastening portion 602 is formed at the end of the external nipple 600, and the second fastening portion 602 corresponds to the third fastening portion 323 formed in the cooling block 310. Therefore, the bolt B inserted in the process of coupling the external nipple 600 to the outer surface of the battery casing 20 is also inserted into the third fastening portion 323 of the cooling block 310. In the process of inserting the bolt B into the third fastening portion 323 of the cooling block 310, the seal 500 inserted into the first insertion groove 312 is further compressed, thereby enhancing the sealing function.

In some implementations, a second insertion groove 23 can be formed along the perimeter of the middle hole 22 of the battery casing 20 to which the external nipple 600 is coupled. A seal 501 (second seal) can also be inserted into the second insertion groove 23 to seal a gap between the outer surface of the battery casing 20 and the external nipple 600.

Although specific embodiments of the present disclosure have been described for illustrative purposes, those skilled in the art will appreciate that various modifications, additions, and substitutions are possible, without departing from the scope and spirit of the present disclosure as disclosed in the appended claims.

What is claimed is:

1. A battery, comprising:
a lower panel having an open upper surface, the lower panel defining a cooling flow path configured to carry a cooling medium;
an upper panel that covers the open upper surface of the lower panel and has a cooling medium inlet hole and a cooling medium outlet hole that are defined at an end portion of the upper panel; and
a cooling pipe part connected to the cooling medium inlet hole and the cooling medium outlet hole, the cooling pipe part being configured to circulate the cooling medium into and out of the cooling flow path of the lower panel,
wherein the lower panel, the upper panel, and the cooling pipe part are joined to one another to thereby define a battery cooling channel.

2. The battery of claim 1, further comprising:
a battery casing,
wherein the lower panel defines a slot hole that couples the battery cooling channel to the battery casing, the slot hole being defined at a side surface of the lower panel.

3. The battery of claim 2, wherein the slot hole has an oval shape having a major axis and a minor axis shorter than the major axis.

4. The battery of claim 1, further comprising a battery pack disposed at an upper surface of the upper panel.

5. The battery of claim 1, further comprising:
a thermal interface material (TIM) layer disposed at an upper surface of the upper panel; and
a battery pack disposed at an upper surface of the TIM layer.

6. The battery of claim 2, further comprising a buffer member that is disposed at an inner surface of the battery casing,
wherein the battery cooling channel is disposed at an upper surface of the buffer member.

7. The battery of claim 1, further comprising:
a battery casing,
wherein the cooling pipe part comprises:
a cooling block having a first surface that is in contact with an inner surface of the battery casing and defines (i) a passage configured to provide the cooling medium toward the battery casing from an outside of the battery casing and (ii) a passage configured to provide the cooling medium outward from the battery casing to the outside; and
a cooling nipple having (i) a first end connected to one of the cooling medium inlet hole or the cooling medium outlet hole and (ii) a second end connected to a second surface of the cooling block.

8. The battery of claim 7, wherein the first end of the cooling nipple is connected to the upper panel by brazing with the cooling medium inlet hole or the cooling medium outlet hole, and
wherein the cooling block and the second end of the cooling nipple are joined to each other by brazing.

9. The battery of claim 7, wherein the battery casing defines a forming portion that is recessed from the inner surface of the battery casing and that has a shape corresponding to the cooling block,
wherein the battery casing is configured to fix a position of the battery cooling channel in longitudinal, width, and height directions based on the first surface of the cooling block being inserted into the forming portion.

10. The battery of claim 7, wherein the cooling block defines a through-hole that extends through the cooling block and is connected to the second end of the cooling nipple.

11. The battery of claim 10, further comprising a first seal, wherein the cooling block defines a first insertion groove at the first surface of the cooling block, the first insertion groove receiving the first seal.

12. The battery of claim 11, wherein the first insertion groove is defined along an edge of the cooling block or along a perimeter of the through-hole.

13. The battery of claim 10, further comprising a plurality of seals, wherein the cooling block defines a plurality of first insertion grooves at the first surface of the cooling block, each of the plurality of first insertion grooves receiving one of the plurality of seals.

14. The battery of claim 13, wherein the plurality of first insertion grooves include (i) a first groove defined along an edge of the cooling block and (ii) a second groove defined along a perimeter of the through-hole.

15. The battery of claim 10, wherein the battery casing defines a middle hole at a position corresponding to the through-hole of the cooling block, the middle hole extending through the battery casing and being in fluid communication with the through-hole of the cooling block.

16. The battery of claim 15, further comprising an external nipple inserted into the middle hole and the through-hole from an outer surface of the battery casing,
wherein the external nipple and the cooling nipple are in fluid communication with each other.

17. The battery of claim 16, further comprising a seal,
wherein the cooling block and the external nipple are fastened to each other by bolting, and
wherein the battery casing defines an insertion groove along a perimeter of the middle hole, the insertion groove receiving the seal.

18. The battery of claim 10, further comprising:
a first seal disposed between the battery casing and the cooling block, wherein the cooling block defines a first insertion groove at the first surface of the cooling block, the first insertion groove receiving the first seal;
an external nipple inserted into the through-hole from an outer surface of the battery casing; and
a second seal disposed between the external nipple and the battery casing, wherein the battery casing defines a second insertion groove receiving the second seal.

19. The battery of claim 18, wherein the first seal is one of a plurality of seals that are disposed between the battery casing and the cooling block, the plurality of seals being disposed along (i) an edge of the cooling block and (ii) a perimeter of the through-hole.

20. A battery, comprising:
a lower panel having an open upper surface, the lower panel defining a cooling flow path configured to carry a cooling medium;
an upper panel that covers the open upper surface of the lower panel and has a cooling medium inlet hole and a cooling medium outlet hole that are defined at an end portion of the upper panel;
an inlet cooling pipe connected to the cooling medium inlet hole; and
an outlet cooling pipe connected to the cooling medium outlet hole,
wherein the inlet and outlet cooling pipes are joined to the upper panel by brazing.
